(19) United States
(12) Patent Application Publication
(10) Pub. No.: US 2024/0392594 A1
(43) Pub. Date: Nov. 28, 2024

(54) ALGAECIDE DISPENSERS

(71) Applicant: King Technology, Inc., Minnetonka, MN (US)

(72) Inventors: David Guy, Maple Grove, MN (US); Jeffrey D. Johnson, Edina, MN (US); Brett Libby, Edina, MN (US)

(21) Appl. No.: 18/792,997

(22) Filed: Aug. 2, 2024

Related U.S. Application Data
(63) Continuation of application No. 17/687,946, filed on Mar. 7, 2022, now Pat. No. 12,054,962.
(60) Provisional application No. 63/207,570, filed on Mar. 8, 2021.

(51) Int. Cl. E04H 4/12; C02F 1/50; C02F 1/52; C02F 103/42

(52) U.S. Cl. CPC E04H 4/1281; E04H 4/1272; C02F 1/50; C02F 1/52; C02F 2103/42

(57) ABSTRACT

A method and dispenser for maintaining a body of water in a swimming pool free of algae with the dispenser water mateable to a surface within a skimmer basket to deliver at least one dispersant to the pool water flowing through the skimmer basket.

### CROSS-REFERENCE TO RELATED APPLICATIONS

This application is a continuation of U.S. patent application Ser. No. 17/687,946, filed on Mar. 7, 2022, which claims the benefit of prior filed U.S. Provisional Patent Application No. 63/207,570, filed on Mar. 8, 2021, the contents of each of which are hereby incorporated by reference in their entirety.

### TECHNICAL FIELD

This invention relates generally to recreational bodies of water such as swimming pools and, more specifically, to a basket dispenser where a single or multiple dispersants can be dispensed into the body of water.

### BACKGROUND

One aspect of maintaining a swimming pool is to avoid the growth or outbreak of algae in the pool water, i.e., an algae bloom, which one avoids by adding an algaecide to the pool water. One of the most effective algaecides is copper, which may be combined with a chelating agent to decrease staining.

One of the challenges in using copper as an algaecide (for example, copper sulfate) is to avoid unsightly copper stains on the pool structure since copper stains the pool structure if one allows the copper to remain in contact with the pool structure. Other factors may also cause copper staining including improper water balance, for example the pH of the pool water is too high.

Typically, copper algaecides are available in liquid or granular form, i.e., loose particles or compressed particles, which may or may not be diluted with water. Copper algaecides are also available in metallic form that may be either ionized or non-ionized.

Depending on the form of the copper algaecide there are various methods one may use to minimize or prevent copper staining including preventing the copper in the algaecide from coming into sustained direct contact with the pool structure. For example, one way to minimize copper staining is to dilute the copper algaecide before it is added to the pool water. That is, if the copper algaecide without dilution is added directly to the main body of water the copper algaecide, which is heavier than water, may settle in the bottom of the pool and cause staining on the bottom of the pool.

Typically, in maintaining bodies of recreational water, such as swimming pools, dispersants are controllably delivered into a swimming pool through a dispenser located in an inline dispensing valve, which is located in a pool water circulation system, or through a floating dispenser, which is located in the open body of water in the swimming pool.

Another type of dispenser is an inline dispenser that contains a dispersant in an open sided cage, which is placed in a swimming pool pump basket. The open sided cage delivers a dispersant into a swimming pool pump basket through a set of end and side openings as the open sided cage can tumble about in a swimming pool pump basket.

### SUMMARY

A pool pump basket dispenser metering one or more dispersants with the pool pump basket dispenser having a water mateable surface to support the pool pump basket dispenser in a stable dispensing condition as a dispersant therein is diluted and metered into a stream of pool water as the stream of pool water flows through the pool pump basket.

### BRIEF DESCRIPTION OF THE DRAWINGS

FIG. 1 shows a typical prior art swimming pool system with a pool pump that circulates water throughout the swimming pool.

FIG. 2 shows a prior art open sided cage that one drops into a pool pump basket.

FIG. 3 shows a deformable pool pump dispenser that is water mateable to an internal structural surface of a pool pump basket.

FIG. 4 shows the deformable pool pump dispenser of FIG. 3 mated to an interior surface of the pool pump basket.

### DETAILED DESCRIPTION

One aspect of maintaining a swimming pool is to avoid the growth or outbreak of algae in the pool water, i.e., an algae bloom, which one can avoid by adding an algaecide to the pool water. One of the most effective algaecides is copper, which may be combined with a chelating agent to decrease staining.

One of the challenges with using copper, as an algaecide, for example copper sulfate, is to avoid unsightly copper stains on the pool structure since copper can stain the pool structure if copper is allowed to remain in contact with the pool structure. Other factors can cause copper staining including improper water balance, for example if the pH of the pool water is too high.

Typically, copper algaecides are available in liquid or granular form, i.e., loose particles or compressed particles, which may or may not be diluted with water. Copper algaecides are also available in metallic form that may be either ionized or non-ionized.

Depending on the form of the copper algaecide there are various methods one may use to minimize or prevent copper staining including preventing the copper in the algaecide from coming into sustained direct contact with the pool structure. For example, one way to minimize copper staining is to dilute the copper algaecide before it is added to the pool water. That is, if the copper algaecide is added directly to the main body of water the copper algaecide, which is heavier than water, may settle in the bottom of the pool and cause staining on the bottom of the pool.

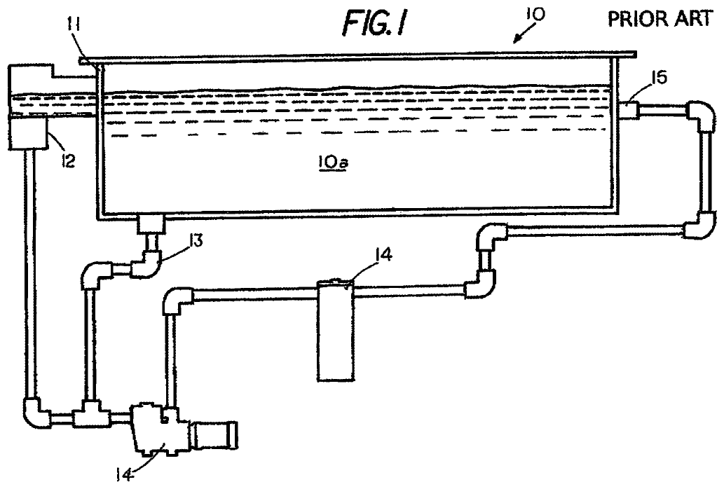

FIG. 1 shows a typical prior art swimming pool 10 with a body of water 10a and a water circulation system, which includes a set of water outlets comprising a skimmer 12 and a drain 13 that directs pool water into a pool pump 14a. Pool pump, which contains a removable pool pump basket, circulates pool water through the pool pump basket and an inline dispensing valve 14a before returning the water to pool 10 through a water inlet 15 located on a side of pool 10.

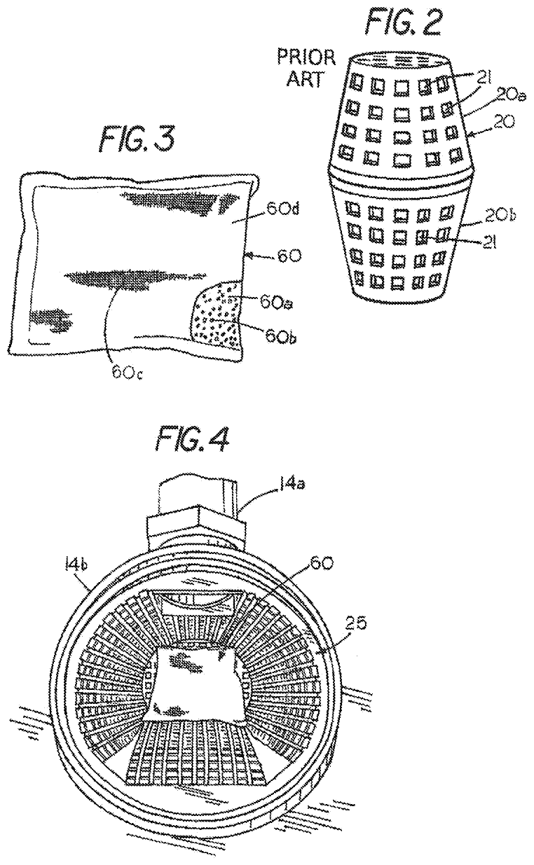

FIG. 2 shows a prior art bulging belly dispensing cage 20 with a circular end of a first truncated hollow conical section 20a joined to a circular end of a second truncated hollow conical section 20b to form a dispersant compartment therein. Rows of rectangular shaped openings 21 in cage 20 allow a dispersant therein to escape from within the bulging belly dispensing cage 20. After the belly bulged dispensing cage 20 has been dropped into a pool the cage 20 can tumble about in the pool pump basket as the contents in the cage are released into the water in the pool pump basket.

In one embodiment of the invention the mateable pool pump basket dispenser 60 comprises a flexible fabric water porous immersible algaecide packet 60d that is held in a stable dispensing condition as water flows through the pool pump basket and the algaecide packet 60d.

In another example, the algaecide packet 60d comprises a woven mesh bag, for example, a spun fiber mesh bag that allows water to flow into and out of the pores or openings in the algaecide packet when the algaecide packet is located in a pump basket of a swimming pool system. The algaecide packet 60d may take various forms and may include a coating on the outside of the packet comprising a dissolvable material (PVA or the like) to retain the contents within the algaecide packet during shipping and handling of the algaecide packet as well as prior to placing the algaecide packet into a pump basket in a swimming pool circulation system.

In the present invention, the dilution of the algaecide in the water porous packet 60d (FIG. 3) becomes controllable by selecting the appropriate water porosity of the packet. That is, the pores or openings in the packet limit or meter water into and out of the packet since the size of the pores as well as the boundary layer proximate the pores provide a flow resistance usable to control the velocity of water into and out of the packet and consequently the rate of the algaecide dispersant into the pool pump basket. The flow resistance of pool pump water through packet 60d provides a further benefit since the flexible packet 60d can be water mateably held in a dispensing condition against a set of openings in a pool pump basket during flow of water through the pool pump basket 25.

Examples of algaecides 60b, such as copper metallic material, which are located within the algaecide packet 60d may take various forms including sheets, foil, shot, wire, or ribbon. Alternately, one may impregnate the algaecides 60b directly into the mesh of the algaecide packet 60d.

Location for the algaecide packet is preferably in the pool pump basket 14 of a swimming pool 10, however, in some instances the skimmer basket or leaf catcher basket may be used. In addition, one may install the algaecide packet in a custom built in-line housing, for example, an in-line housing that attaches to a fitting on a return side of the swimming pool water circulation system.

The algaecide packet 60d may contain a float for easy and quick removal of a spent algaecide packet from within the pool circulation system.

While a mesh algaecide packet 60d is described other types of water-mateable packets made from materials such as a flexible or water deformable materials may be used. That is, the packet material needs to permit water to simultaneously flow around and through packet 60d to contact the algaecide therein when the packet 60d is water-mated to a surface of pool pump basket 25 through a flow water though the pool pump basket 25.

To retain the algaecide packet 60d, which is flexible, within the pool circulation system a clip or connector may be used to temporarily secure the algaecide packet to structure within the pool circulation system as water continues to flow through the algaecide pocket.

A further example of an algaecide packet 60d is a coated packet, i.e., a dissolvable Poly Vinyl Alcohol (PVA) material located on the exterior of the packet 60d to retain the contents of the algaecide packet during shipping and handling.

Examples of the types of other copper metallic material, which are usable within a pool pump dispenser such as algaecide packet 60d, include copper in a variety of forms, for example, copper in sheet, foil, shot, wire or ribbon form.

In some cases, the locations for the algaecide packet may be in locations other than the pump basket such as a skimmer basket, a leaf catcher basket, a purpose-built algaecide cartridge in-line housing or a purpose built housing that attaches to one of the return fittings on the pool circulation system.

In the example of the algaecide packet 60d described herein, the algaecide packet may contain an algaecide and a cocktail of chelators located therein to allow pool water flow into and out of the algaecide packet as the algaecide packet is restrained within a pool pump basket, i.e., water mated within a pump basket in a swimming pool circulation system caused by a combination of the flexibility of the packet and the forces on the packet generated from the flow of water through a pool pump basket and the packet within the pool pump basket.

One example of an algaecide packet 60b to destroy algae and limit copper staining in a swimming pool includes copper sulfate pentahydrate and a zinc sulfate monohydrate plus a cocktail of at least two chelators wherein the chelators are selected from the group consisting of zinc sulfate, ethylenediamine tetraacetic acid (EDTA), sodium gluconate, triethanolamine hydrochloride and citric acid.

Another example of an algaecide packet with a cocktail of chelators suitable to destroy algae and limit copper staining comprises an algaccide packet that contains 50% Copper Sulfate Pentahydrate by weight and 10% Zinc Sulfate by weight, where the cocktail of chelators comprises 10% ethylenediamine tetraacetic acid (EDTA) by weight, 10% Sodium Gluconate by weight, 10% Triethanolamine Hydrochloride by weight, and 10% Citric Acid by weight.

Other features of the algaecide packet 60d described herein may include a float within the algaecide packet for easy removal of a spent algaecide packet from a pool circulation system.

The algaecide packet 60d described herein may include a clip that allows the algaecide packet to be retained within other parts of the system, for example by attaching the algaecide packet to the skimmer basket handle or a lip of a pump basket.

A benefit of the algaecide packet described herein is that when the packet is placed in a pump basket, the packet delivers or meters a slow release of a chelated copper-based algaecide that is mixed with and diluted by the pool water in the pump basket. Consequently, by the time the water diluted algaecide reaches the main area of the pool, the chances of staining the pool are substantially diminished or eliminated. A feature of the invention is that the porosity of the packet may be used to control or limit the velocity or the amount of water that flows through the algaecide packet and hence a dispersant rate of a copper containing algaecide.

In one example of the invention described herein, the algaecide packet hinders and prevents copper staining by addition of a source of copper ions and cocktail of chelators where all of the active contents of the algaecide packet are in powder form.

The all-solid powder ingredients in algaecide packet may include solid triethanolamine hydrochloride instead of the more commonly used liquid triethanolamine. The all-solid or powder ingredients provide a cost-effective manufacturing process since the solid triethanolamine hydrochloride eliminates the steps of dissolving and drying the ingredients of the contents of the algaecide packet.

A further benefit of the algaecide packet described herein is that one can include a mineral based sanitizer in conjunction with an algaecide packet to simultaneously provide the benefits of both a sanitization agent and algaecide, which may be in a single dispenser.

FIG. 4 shows a pool pump water-mateable dispenser 60, i.e., a water deformable algaecide dispenser 60, which may be a porous fabric, which comprises a water porous immersible algaecide packet 60d containing a copper based algaecide 60b and a cocktail of chelators 60a with the algaecide packet 60d placeable in a water mating condition in a swimming pool pump basket to mix copper ions from a copper based algaecide 60b and the chelators 60a into the water flowing though the pool pump basket 25 to minimize staining of the pool structure as the pump circulates pool water through the swimming pool water circulation system as shown in FIG. 1.

FIG. 4 shows the pool pump water-mateable dispenser 60 in a water-mated condition at a bottom of the swimming pool pump basket 25. The water-mateable dispenser 60 is held in position through water pressure created by the resistance to water flowing through the fabric or material of the dispenser 60 and the dispersants 60a and 60b located in dispenser 60. That is, a particle and fabric resistance of the water-mateable dispenser 60. In this example the dispenser 60, which includes dispersants such as an algaecide 60b that includes a source of copper ions and a cocktail of chelating agents 60a, forms a water porous packet 60d that is placeable within a swimming pool water circulation system to deliver copper ions throughout the swimming pool while minimizing or preventing copper ions in the algaecide from staining the pool structure.

In another example, one may minimize copper staining by diluting the copper based algaecide and slowly metering the copper based algaecide into the pool water at a location upstream of a water pump impellor on the pool circulation system thereby mixing copper algaecide with the pool water and thus diluting the copper algaecide before it flows through the external structure of the pool recirculation system. While mixing and diluting the algaecide 60b can ideally be performed by placing water-mateable dispenser 60 in a pool pump basket of the swimming pool, the dispenser 60 is not limited to placement in the pool pump basket as long as water can flow through packet 60d.

In the example shown, the water-mateable dispenser 60 may contain a copper based algaecide and a cocktail of chelators thereby forming an algaecide packet 60d placeable directly in a swimming pool pump basket 25 to mix copper ions from the copper based algaecide and the chelators 60b into the pool water to minimize staining of the pool structure as the pool pump 14 circulates pool water through the swimming pool water circulation system and the water-mateable dispenser 60, which is located in the swimming pool pump basket. The algaecide 60b including a source of copper ions and a cocktail of chelating agents 60a that are contained in a flexible water-mateable dispenser 60 namely, a flexible water-mateable porous packet 60d placeable within a pool pump basket 25. The suction from the pool pump 14 holding water-mateable dispenser 60 in a stable water-mateable contact with a portion of the porous pool pump basket 61 to avoid uneven dispensing due to tumbling of the water-mateable dispenser 60 in the pool pump basket.

During operation, pump 14 of the pool water circulation system (as shown in FIG. 1) delivers copper ions throughout the swimming pool while minimizing or preventing the copper ions in the algaecide from staining the pool structure by in situ diluting the copper based algaccide within the algaecide packet 60d and slowly metering the diluted copper based algaecide into the pool water through the porous sides of water-mateable dispenser 60, which is at a location upstream of a water pump impellor on a pool circulation system. Thus, the invention described herein enables one to mix and dilute the copper algaecide with the pool water before the copper algaecide flows through the external structure of the pool recirculation system and into the swimming pool thereby minimizing or eliminating staining of the pool structure.

In the example shown in FIG. 3 and FIG. 4, the pool pump water-mateable basket dispenser 60 comprises a packet 60d having a water porous flexible fabric 60c forming a compartment therein that contains an algaecide 60b and chelators 60a that are confined within the compartment formed by the water porous flexible fabric 60c. In this example the water-mateable dispenser 60 (i.e., packet 60d) is placeable in a dispensing condition within a pool pump basket with the water porous flexible packet 60d having sufficient porosity and flexibility to allow water to be drawn through the flexible fabric 60c and the algaccide 60b therein as a stream of water is sucked though the pool pump basket 25 by a pump located downstream of the pool pump basket 25.

In this example, the porosity of the fabric 60c and the velocity of the water through the pool pump basket 25 can be adjusted to ensure that the algaecide therein is properly mixed. Thus, selecting the appropriate water porosity of fabric 60c can be used to control the dispensing rate when water mateable dispenser 60 is held in a water mateable condition in a pool pump basket. That is, the pores or openings in the packet fabric 60c function to meter water into and out of the packet 60d during water flow therethrough since the size of the pores as well as the boundary layer proximate the pores or openings in fabric 60c provide a flow resistance that can be used to control the velocity of water into and out of packet 60d and consequently the rate of the algaccide dispensed into pool pump basket 25.

An example of an algaecide for use in water-mateable dispenser 60 is a dry copper algaecide 60b. In this example, water-mateable dispenser 60 comprises a rectangular packet 60d that is supportable in a water-mated dispensing condition in a pool pump basket through water pressure that deforms the packet 60d to maintain the packet in stable dispensing condition. That is, a flow deformation of the packet 60d causes the packet 60d to remain in a stable dispensing condition through an interlocking engagement of flexible fabric 60c of packet 60d with a web structure of the pool pump basket.

Preferably, at least a portion of the flexible fabric 60c of water-mateable dispenser 60 has pores or openings sufficiently large therein for ingress and egress of water through the fabric 60c of packet 60d to thereby disseminate algaecide 60b in a diluted condition into a stream of water flowing through the pool pump basket while also preventing undiluted algaccide in packet 60d from flowing out of the water-mateable dispenser 60.

In another example, water-mateable dispenser 60, which comprises an algaecide packet 60d, may be a woven mesh bag with an algaecide therein, for example, a spun fiber mesh bag that allows water to flow into and out of the pores or openings in the algaecide packet 60d when the algaecide packet is located in a swimming pool system. The water-mateable dispenser 60 may take various other forms and may include a coating on the outside of an algaecide packet 60d where the coating comprises a dissolvable material (PVA or the like) to retain the contents within the algaecide packet 60d during shipping and handling of the algaecide packet as well as prior to placing the algaecide packet into a pool pump basket in a swimming pool circulation system.

Examples of algaccides such as copper metallic material located within the algaccide packet 60d may take various forms including sheets, foil, shot, wire, or ribbon. Alternately, one may impregnate the algaecide directly into the mesh of the algaecide packet 60d.

As described herein, the location for the algaecide packet 60d is preferably the pool pump basket of a swimming pool, however, the skimmer basket or leaf catcher basket may be used in certain pool systems. In addition, one may install the algaecide packet 60d in a custom built in-line housing, for example, an in-line housing that attaches to a fitting on a return side of the swimming pool water circulation system.

The algaecide packet 60d may contain a float for easy and quick removal of a spent algaccide packet from within the pool circulation system.

While a mesh flexible algaecide packet 60d is described, other types of algaecide packets may include, for example, a polymer plastic housing to permit water to flow around and through openings in the housing to contact the algaecide therein.

To retain the algaecide packet 60d within the pool circulation system, a clip or connector may be used to temporarily secure the algaccide packet to structure within the pool circulation system.

A further example of an algaecide packet 60d is a coated packet, i.e., a dissolvable (polyvinyl acetate) or other material, which is located on an exterior face of the algaecide packet 60d to retain the powder contents of the algaecide packet during shipping and handling.

Examples of the type of copper metallic material usable within an algaecide cartridge or algaecide packet 60d includes copper in a variety of forms including copper in sheet, foil, shot, wire or ribbon form.

In some cases, the locations for the algaecide packet 60d may be in locations other than the pump basket such as a skimmer basket, a leaf catcher basket, a purpose-built algaecide cartridge in-line housing or a purpose built housing that attaches to one of the return fittings on the pool water circulation system.

In the example of the algaecide packet 60d described herein, the algaecide packet preferably contains an algaecide and a cocktail of chelators located therein to allow pool water flow into and out of the algaecide packet as the algaecide packet is typically restrained within a pump basket in a swimming pool circulation system through the water mateable feature of dispenser 60.

In one example, an algaecide packet 60d, which can be used to destroy algae and limit copper staining in a swimming pool, includes copper sulfate pentahydrate and zinc sulfate monohydrate and a cocktail of at least two chelators wherein the chelators are selected from the group consisting of, ethylenediamine tetraacetic acid (EDTA), sodium gluconate, triethanolamine hydrochloride and citric acid.

An example of an algaecide packet 60d with a cocktail of chelators suitable to destroy algae and limit copper staining comprises an algaecide packet that contains 50% Copper Sulfate Pentahydrate by weight where the cocktail of chelators comprises 10% Zinc Sulfate by weight, 10% ethylenediamine tetraacetic acid (EDTA) by weight, 10% Sodium Gluconate by weight, 10% Triethanolamine Hydrochloride by weight, and 10% Citric Acid by weight.

Other features of the algaecide packet 60d may include a float within the algaecide packet for easy removal of a spent algaecide packet from the pool circulation system.

Still other features of the algaecide packet 60d described herein may include a clip to restrain the algaecide packet by attaching the algaecide packet 60d in a water mateable condition on a skimmer basket handle or a lip of a pool pump basket.

A benefit of the water mateable algaecide packet 60d described herein, which is placed in a pump basket, is that the algaecide packet 60d delivers a slow release of a chelated copper-based algaecide that is mixed and diluted by the pool water in the pump basket so that when the diluted algaecide reaches the main area of the pool, the chances of staining the pool are prevented or substantially diminished.

In one example, the algaecide packet 60d hinders and prevents copper staining via addition of a source of copper ions and a cocktail of chelators in the algaecide where all of the active contents of the algaecide packet are in powder form.

All-solid powder ingredients in algaecide packet 60d may include solid triethanolamine hydrochloride instead of the more commonly used liquid triethanolamine. The all-solid or powder ingredients provide a cost-effective manufacturing process since the solid triethanolamine hydrochloride eliminates the steps of dissolving and drying the ingredients of the contents of the algaecide packet 60d.

A further benefit of the algaecide packet 60d described herein is that one can include a mineral based sanitizer in conjunction with an algaecide packet to simultaneously provide the benefits of both a sanitization agent and an algaecide, which may be in a single dispenser.

Thus, in a swimming pool dispensing system, one can including an algaecide located within a packet 60d containing a copper algaecide, wherein the packet 60d resides in a pump basket of a water circulation system of a swimming pool.

In some examples, packet 60d can contain an algaecide/clarifier/flocculent composition that is all-solid powder that can be compressed into either a pellet or a tablet for insertion into a pool pump basket.

In other examples, packet 60d can be part of an algaecide/clarifier/flocculent delivery method that consists of adding a first liquid chelator to a swimming pool and a powder algaecide to a pump basket or adding a first liquid chelator to a swimming pool and a powder algaecide to a skimmer basket. Alternately, a combination algaecide/clarifier/flocculent product can be formed consisting of both a copper algaecide and a silver sanitizer as a single mixed all-solid product.

A further feature of the flexible deformable packet 60d is that one can control pump flow rate to control the amount or rate of dispensing the algaecide into the pool thereby allowing one to use a variety of algaecides since the water mateable packet can maintain its dispensing position as the water flow therethrough is increased or decreased.

### Test Results

To test the effectiveness of a deformable water-mateable dispenser, a set of 5 in×5 in fabric packets were made from Polypoint 200HEM, Spun, Spunbound Pointbond Polyester, 15-Micron rating (supplied by Hanes Engineered Materials of Sharonville Ohio)

The contents of the field-tested water-mateable packets were as follows:
Copper Sulfate Pentahydrate (50% by weight)
Zinc Sulfate (clarifier 10% by weight)
Ethyelenediaminetetraccetic acid (chelant 10% by weight)
Triethanolamine (chelant 10% by weight)
Citric Acid (chelant 10% by weight)
Sodium Gluconate (chelant 10% by weight)

For 15,000-gallon pools, the water-mateable packet size was 5 in ×5 in when empty and 4 in ×4 in ×1 in when filled with the above contents.

For 15,000-gallon pools, the water-mateable packet size was 5 in ×7.5 in when empty and 3.5 in ×6 in ×1.5 in when filled with the above contents.

The packets were placed in the pool pump basket of 750 different pools up to 25,000 gallons. No algae outbreaks or staining were reported during a 6-month test period.

1. A swimming pool system comprising:
a swimming pool;
a skimmer basket having a plurality of openings therein for separating debris from pool water that flows through the skimmer basket and into a pool water circulation line;
a pool pump basket having a plurality of openings therein, the pool pump basket located on an inlet side of a pool pump in the pool water circulation line;
a water-deformable algaecide dispenser located in the skimmer basket, the water-deformable algaecide dispenser having openings therein to permit flow of the pool water therethrough, the water-deformable algaecide dispenser having an external water-mateable surface mateable to an internal surface of the skimmer basket in response to a water pressure exerted by the pool water being drawn though the water-deformable algaecide dispenser in the skimmer basket while allowing water and debris to move within the skimmer basket;
an algaecide located in the water-deformable algaecide dispenser; and
the pool pump configured to draw the pool water into the skimmer basket and through the algaecide in the water-deformable algaecide dispenser before releasing the pool water with the algaecide in a diluted condition into the swimming pool through the pool water circulation line.

2. The swimming pool system of claim 1 wherein the water-deformable algaecide dispenser comprises a flexible porous fabric packet that conforms to a shape of the skimmer basket as the pool water flows through the skimmer basket and the flexible porous fabric packet to restrain the flexible porous fabric packet in a stable dispensing position against an interior of the skimmer basket.

3. The swimming pool system of claim 2 wherein the flexible porous fabric packet is restrained in the stable dispensing position against the interior of the skimmer basket through an interlocking engagement of flexible fabric of the packet with a web structure bounding openings of the skimmer basket.

4. The swimming pool system of claim 2 wherein the flexible porous fabric packet is in the form of a rectangular packet, whereas a bottom of the skimmer basket has a circular shape, and the flexible porous fabric packet is configured to conform to the shape of the skimmer basket as the pool water flows through the skimmer basket and the flexible porous fabric packet to maintain the flexible porous fabric packet in the stable dispensing position when simultaneously in contact with both the bottom of the skimmer basket and a sidewall of the skimmer basket.

5. The swimming pool system of claim 2 wherein the flexible porous fabric packet is configured to allow some of the pool water to flow through the flexible porous fabric packet while simultaneously allowing some of the pool water to flow around the flexible porous fabric packet while the flexible porous fabric packet remains in the stable dispensing position.

6. The swimming pool system of claim 1 wherein there are openings in both a bottom and a sidewall of the skimmer basket in which the water-deformable algaecide dispenser is located, the water-deformable algaecide dispenser comprising a flexible fabric packet having pores or other openings sized to permit ingress and egress of water and to permit flow of the algaecide out of the dispenser in the diluted condition while preventing the algaecide from flowing out of the dispenser in undiluted form.

7. The swimming pool system of claim 6 wherein the sidewall of the skimmer basket extends upwardly from the bottom of the skimmer basket, and the openings are in both the sidewall and the bottom of the skimmer basket.

8. The swimming pool system of claim 7 wherein the water-deformable algaecide dispenser is located in the skimmer basket such that the water-deformable algaecide dispenser is surrounded by the sidewall of the skimmer basket, the sidewall having a plurality of the openings.

9. The swimming pool system of claim 1 wherein the algaecide comprises a source of copper and a cocktail of chelators.

10. The swimming pool system of claim 9 wherein the water-deformable algaecide dispenser contains all-solid powder ingredients including the source of copper and the cocktail of chelators.

11. The swimming pool system of claim 9 wherein the all-solid powder ingredients in the dispenser include solid triethanolamine hydrochloride.

12. The swimming pool system of claim 10 wherein the all-solid powder ingredients further include a mineral based sanitizer, such that the water-deformable algaecide dispenser is a single dispenser having both a sanitization agent and the algaecide.

13. A method of using a water-deformable algaecide dispenser in a swimming pool system that includes a skimmer basket, wherein the water-deformable algaecide dispenser comprises a flexible fabric packet and contains an algaecide, the flexible fabric packet having pores or other openings sized to permit ingress and egress of water and to permit flow of the algaecide out of the dispenser in a diluted condition while preventing the algaecide from flowing out of the dispenser in undiluted form, the skimmer basket having a bottom and a sidewall, the sidewall extending upwardly from the bottom, and there are openings in both the sidewall and the bottom, the method comprising placing the water-deformable algaecide dispenser in the skimmer basket such that the water-deformable algaecide dispenser is retained against the skimmer basket's bottom, which has a plurality of the openings, and is surrounded by the skimmer basket's sidewall, which also has a plurality of the openings.

14. The method of claim 13 wherein the flexible fabric packet conforms to a shape of the skimmer basket as pool water flows through the skimmer basket and the flexible fabric packet to retain the flexible fabric packet in a stable dispensing position against the skimmer basket's bottom.

15. The method of claim 14 wherein a flow deformation of the flexible fabric packet causes it to remain in the stable dispensing condition through an interlocking arrangement of flexible fabric of the packet with a web structure of the skimmer basket.

16. The method of claim 14 wherein the flexible fabric packet is in the form of a rectangular packet, whereas a bottom of the skimmer basket has a circular shape, and the flexible fabric packet is configured to conform to the shape of the skimmer basket as the pool water flows through the skimmer basket and the flexible fabric packet to maintain the flexible fabric packet in the stable dispensing position when simultaneously in contact with both the bottom of the skimmer basket and a sidewall of the skimmer basket.

17. The method of claim 14 wherein, while the flexible fabric packet remains in the stable dispensing position, some of the pool water flows through the flexible fabric packet and simultaneously some of the pool water flows around the flexible fabric packet.

18. The method of claim 14 wherein the method includes operating a pool pump to move pool water through the skimmer basket and along a pool water circulation line of the swimming pool system, and the method further includes controlling a flow rate of the pool pump to either increase or decrease pool water flow through the flexible fabric packet while maintaining the flexible fabric packet in the stable dispensing position.

19. The method of claim 18 wherein controlling the flow rate of the pool pump controls a rate of dispensing the algaecide.

20. The method of claim 13 wherein the method is characterized by a downward path of pool water flow into a top side of the flexible fabric packet, through the flexible fabric packet, and out of a bottom side of the flexible fabric packet.

21. The method of claim 13 wherein the water-deformable algaecide dispenser delivers a release of a chelated copper-based algaecide that is mixed with and diluted by pool water.

22. The method of claim 13 wherein the algaecide comprises a source of copper and a cocktail of chelators.

23. The water-deformable algaecide dispenser of claim 22 wherein the water-deformable algaecide dispenser contains all-solid powder ingredients including the source of copper and the cocktail of chelators.

24. The water-deformable algaecide dispenser of claim 23 wherein the all-solid powder ingredients further include a mineral based sanitizer, such that the water-deformable algaecide dispenser is a single dispenser having both a sanitization agent and the algaecide.

25. The water-deformable algaecide dispenser of claim 23 wherein the all-solid powder ingredients further include a silver sanitizer.

26. The water-deformable algaecide dispenser of claim 23 wherein the all-solid powder ingredients in the dispenser include solid triethanolamine hydrochloride.

27. An alegaecide packet for placement in a skimmer basket of a swimming pool water circulation system, the algaecide packet comprising:
a water porous fabric to allow water to flow into and out of the algaecide packet when the algaecide packet is located in the skimmer basket of the swimming pool water circulation system; and
an algaecide located in the packet, the algaecide comprising a source of copper ions, such that the algaecide packet has contents including the source of copper ions, the contents of the algaecide packet including active contents, the active contents being in powder form, the contents of the algaecide packet including a cocktail of chelators, the cocktail of chelators comprising two or more chelators selected from the group consisting of ethylenediamine tetraacetic acid (EDTA), sodium gluconate, triethanolamine hydrochloride, and citric acid.

28. The algaecide packet of claim 27 wherein the contents of the algaecide packet are all-solid powder ingredients that include solid triethanolamine hydrochloride.

29. The algaecide packet of claim 27 wherein the source of copper ions comprises copper sulfate pentahydrate and is provided together with a mineral based sanitizer such that the algaecide packet is a single dispenser having both a sanitization agent and the algaecide.

30. The algaecide packet of claim 27 wherein the cocktail of chelators comprises ethylenediamine tetraacetic acid (EDTA), triethanolamine hydrochloride, and citric acid.

31. The algaecide packet of claim 27 further comprising a coating on an outside of the algaecide packet, such that the coating retains the contents of the algaecide packet during shipping and handling but dissolves in water.

32. The algaecide packet of claim 27 wherein the algaecide packet is a rectangular packet having a rectangular bottom face configured to seat stably directly against a bottom of the skimmer basket.

33. The algaecide packet of claim 32 wherein the rectangular packet also has a top major face that is rectangular.
